(19) United States
(12) Patent Application Publication
(10) Pub. No.: US 2010/0308947 A1
(43) Pub. Date: Dec. 9, 2010

(54) MAGNETIC COUPLING DEVICES

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/867,321

(22) PCT Filed: Feb. 12, 2009
(86) PCT No.: PCT/IB09/50572

§ 371 Date: Aug. 12, 2010

(30) Foreign Application Priority Data
Feb. 14, 2008 (US) 61/028545
Apr. 8, 2008 (US) 61/043138
Jun. 3, 2008 (US) 61/058235

(51) Int. Cl. H01F 7/02

(52) U.S. Cl. 335/306

(57) ABSTRACT

New devices of magnetic couplings, angled and non-angled, with their uses, are presented.

This patent application claims the benefit of U.S. Provisional Patent Application No. 61/028,545, entitled Provisional 2-08: One-directional bearings, Large and Small Wind, Hydro, Blade Design, filed Feb. 14, 2008 and No. 61/043,138, entitled Provisional 4-08 Couplings-FDD-Gears, filed Apr. 8, 2008 and No. 61/058,235, entitled Provisional 6-08: Improvements to renewable energy devices, filed Jun. 3, 2008.

### FIELD AND BACKGROUND OF THE INVENTION

The present invention relates to new devices for magnetic couplings that are especially useful in turbines in an aqueous environment.

Magnetic couplings currently offered are often in the shape of circles within circles (rotary) or a flat pancake with radially directed magnets. A flat and wide magnetic coupling as described herein can be improved by making a matching angle in the alignment of the magnets on each side in relation to the plane perpendicular to the shaft. This, especially when used in a turbine, pump, agitator, or other piece of equipment, is advantageous. Current art, as in U.S. Pat. No. 6,152,704, is to make disc-type couplings completely flat.

The use of electromagnetic couplings in association with turbines, particularly in a fluid environment, is described here. It has the advantage of being easy to disassemble.

The author has previously claimed the use of turbines in association with magnetic couplings in a PCT application IB2008/055016 entitled Construction of an In-pipe Turbine, filed in November 2008. The following claims are relevant to this patent application; this patent application adds to their specificity in angled couplings and thereby differs:

“11. A turbine operating in a fluid, comprising:

a. a set of magnetic couplings connecting the turbine and generator shafts.

12. The turbine of claim 11, wherein the turbine is an in-pipe turbine.”

### BRIEF DESCRIPTION OF THE DRAWINGS

The invention is herein described, by way of example only, with reference to the accompanying drawings, wherein:

FIG. 1 is a diagram of an angled magnetic coupling.

FIG. 2 is a diagram of a radial array of magnets in a magnetic coupling.

FIG. 3 is a diagram of a different array of magnets in a magnetic coupling.

FIG. 4 is a diagram of the placement of bearings in a magnetic coupling.

FIG. 5 is a diagram of two couplings showing the housing removed on one side.

FIG. 6 is a diagram of the two couplings placed together and separated by a distance of 5 mm.

FIG. 7 is a diagram of a magnetic coupling with magnets placed adjacent to each other.

### DESCRIPTION OF THE PREFERRED EMBODIMENTS

The present invention consists of ways to make cheaper and better magnetic couplings, particularly of the flat type.

A magnet set is defined as a group of magnets with at least one magnet. A magnetic coupling will have two magnet sets. A magnetic “couple” refers to one side of a magnetic coupling.

The principles and operation of a magnetic coupling according to the present invention may be better understood with reference to the drawings and the accompanying description.

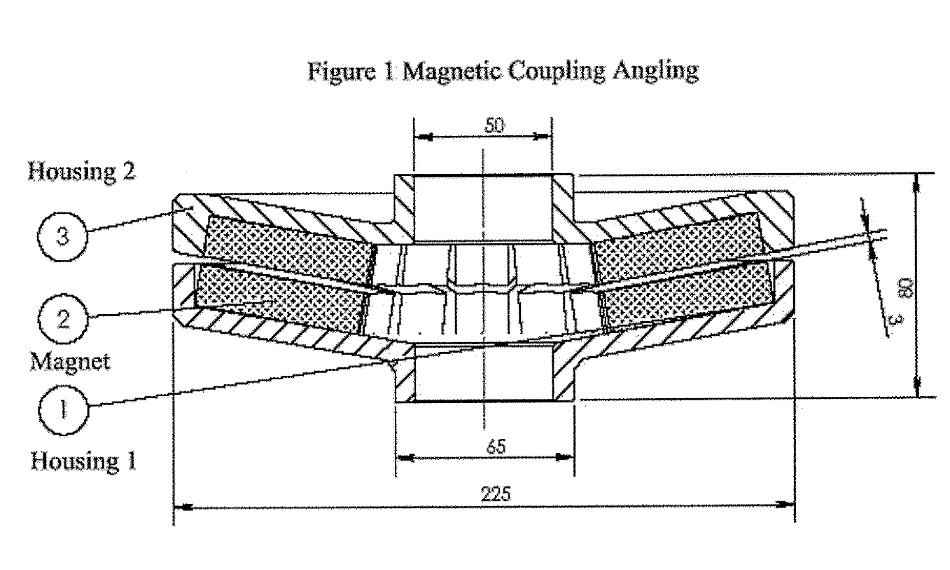

Referring now to the drawings, FIG. 1 illustrates an angled magnetic coupling in a cross-sectional view. The essential components are the magnet sets (2) on each side (matching in angle and opposite in magnetic polarity) in a near-pancake distribution with an angle on each side covered by separate housings (1 and 3). This angle enables a combination of improved connection between the two sides and ability to remove one from the other. The magnets may be permanent or electromagnets; in this embodiment, they are permanent magnets. This can be used in many situations, notably for coupling blades with a generator on the other side of a physical separation. Here we add the invention that for improved performance and for space needs, the two sides of said couplings are optionally placed at an angle, one complementing the other, but retain length and circular shape, so that one looks like a cone and the complementary one like a cone, but attached to a shaft coming from the other direction. The ideal angle embodiment is 10 degrees, plus or minus 5 degrees, but can be from zero to 90 in various embodiments.

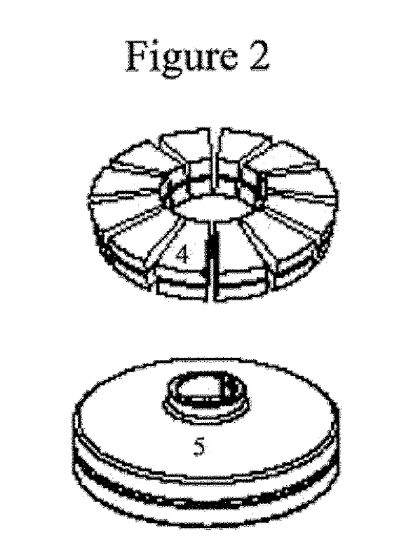

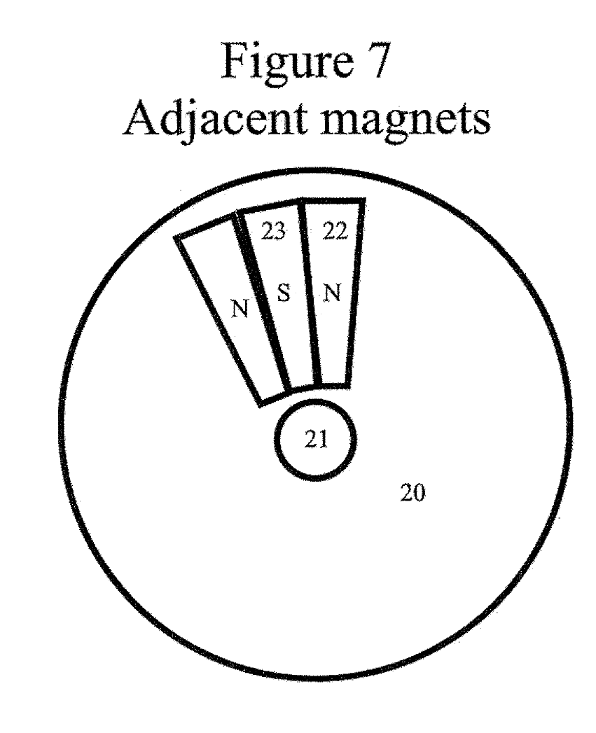

FIG. 2 is a diagram of a radial array of magnets (4) in a magnetic coupling. The two magnet sets are shown in the upper diagram. The entire coupling set with housing (5) is shown in the lower diagram. There is current art like this, but note that there is a space between each radially oriented magnet. There is no current art wherein the magnets are touching, as in FIG. 7, or angled, as in FIG. 1.

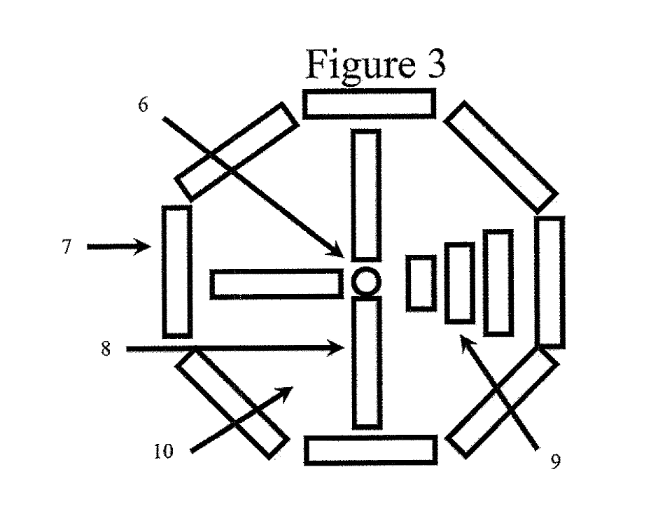

FIG. 3 is a diagram of different arrays of magnets in a magnetic coupling. Couplings need a central hub (6). Therefore, in one embodiment, the invention consists of at least one polyhedral coupling (7) in a circumferential orientation mounted on a holding structure. The coupling may have a mixture of radial (8) and circumferential (9) magnets. In other embodiments, the holding structure can be circular or non-circular, and the magnets can be arranged along the periphery (7). If they are polyhedral, they may be arranged with air gaps (10).

To make up for the lack of concentrated filled-in area, this application introduces the device of a pancake-shaped coupling of a large length to width ratio that takes advantage of higher torque on the periphery. In other embodiments, that can result in a ratio of the radius (from the outer periphery of the magnets used to the center) to magnet thickness (that is, the side of the magnet perpendicular to its direction of attachment to the other coupling) of 5 or more.

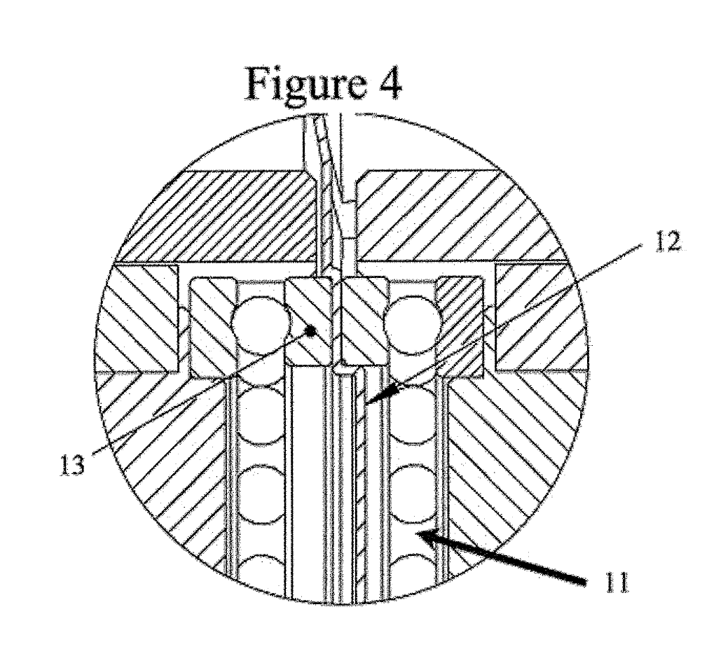

FIG. 4 is a diagram of the placement of bearings in a magnetic coupling. It shows the bearing on both sides (11 and 13) separated by a thin separator (12).

Here we also add the use of a collapsing means for safety. It consists of fillers of various kinds to prevent the attraction between the two sides with the discs and their magnets from causing deformation of the housings. The two lines in FIG. 1 show the location of pressure-type bearings, ideally attached from both sides of a thin metal shell. Other means for preventing collapse from pressure, such as rollers and balls, can be used.

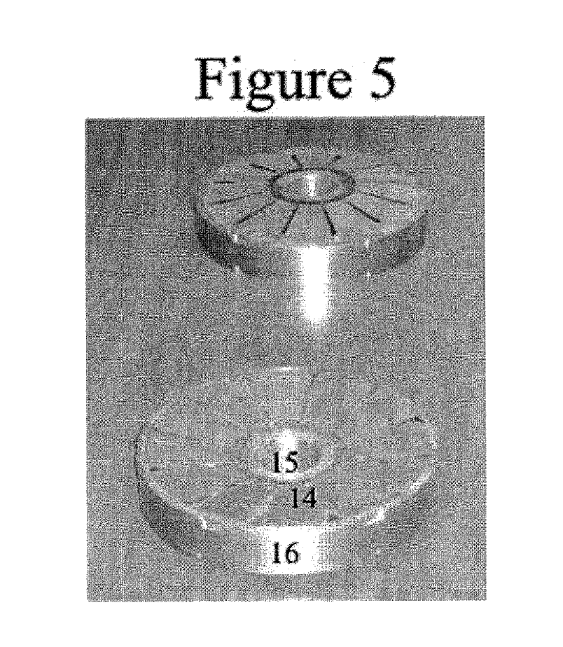

FIG. 5 is a diagram of two couplings showing the housing removed on one side. The magnets (14) are attached to a housing (15) around a central shaft. The remainder of the housing then covers the magnets.

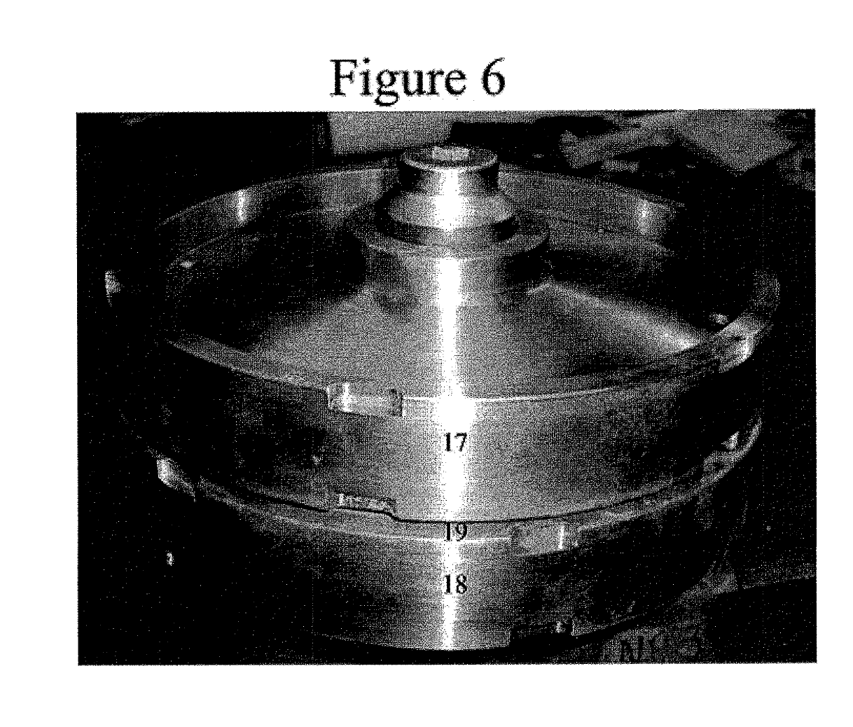

FIG. 6 is a diagram of the two couplings (17 and 18) placed together and separated by a distance (19) of 5 mm in this embodiment.

FIG. 7 is a diagram of a magnetic coupling with magnets placed adjacent to each other and touching. The advantages of doing so are a greater amount of magnet for the space available and greater stability. By directing alternate north and south faces to the matching magnet set, the magnets may be placed adjacent to each other and locked better into place. FIG. 7 is a diagram of one possible configuration. A shaft (21) is attached to a housing (20). In that housing is an array of magnets, in this embodiment trapezoidal and in this embodiment a disc type of coupling, angled or not. The individual magnets (22, 23) are placed tightly next to each other in alternating polarity in order to form a tighter and stronger fit. This may be angled or not angled.

The types of magnetic couplings referred to in this patent application can be used for any type of turbine in a pipe, for pumps, for agitators, and for impeller turbines. We also claim the use of magnetic couplings in underwater impeller turbines, so that the blades cause revolution of one side of the magnetic coupling and the generator is completely sealed off from the blade system but is connected by a magnetic couple. This has the advantage of eliminating contamination from one side to the other.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing new devices for magnetic coupling.

It is now disclosed for the first time a magnetic coupling, comprising:

a. a magnet set on each couple at a matching angle between 1 and 89 degrees to the plane perpendicular to the shaft.

According to another embodiment, at least one of the magnet sets comprises electromagnets. According to other embodiments, said coupling with electromagnets is for use with a turbine or a pump.

According to another embodiment, the angle is 10 degrees, plus or minus 5 degrees, and in various embodiments, used with a turbine or pump.

According to another embodiment, the coupling is for use with an underwater impeller turbine.

It is now disclosed for the first time a magnetic couple, comprising: a magnet set arranged in a radial distribution, wherein at least two magnets are substantially adjacent and of alternating polarity facing the other couple.

In one embodiment, the system further comprises a matching electromagnetic couple.

According to another embodiment, the magnet set is angled between 1 and 89 degrees.

It is now disclosed for the first time a magnetic couple, wherein the magnets are in a circumferential distribution.

According to another embodiment, at least one of the couples comprises electromagnets.

It is now disclosed for the first time a magnetic couple, comprising at least one radially aligned magnet, wherein the ratio of the average length (from the outer periphery of the magnet to the inner periphery) to average thickness (that is, the side of the magnet perpendicular to its direction of attachment to the other coupling) has a ratio of average length to average width of at least 5 to 1

According to another embodiment, the ratio of at least 10 to 1.

According to another embodiment, the magnet set is angled between 1 and 89 degrees.

It is now disclosed for the first time a magnetic coupling, associated with a rotating shaft, comprising an anti-collapsing means between the two sides of the coupling.

According to another embodiment, the means comprises a spring.

It is now disclosed for the first time a magnetic couple, comprising at least one radially oriented magnet and at least one at least partially circumferentially oriented magnet.

1-19. (canceled)

20. A magnetic coupling for use with turbines, comprising:
a. A magnet set on each couple at a matching angle between 1 and 89 degrees to the plane perpendicular to the shaft.

21. The coupling of claim 20, wherein at least one of the magnet sets comprises electromagnets.

22. The coupling of claim 20, wherein the angle is 10 degrees, plus or minus less than 5 degrees.

23. The coupling of claim 22, for use with a pump.

24. The coupling of claim 20, for use with an underwater impeller turbine.

25. The coupling of claim 20, wherein at least one magnet set is arranged in a radial distribution, and wherein at least two magnets are substantially adjacent and of alternating polarity facing the other couple.

26. The coupling of claim 25, further comprising a matching electromagnetic couple.

27. The coupling of claim 25, wherein the magnet set is angled between 1 and 89 degrees.

28. A magnetic coupling, wherein at least one of the magnets is in a circumferential distribution.

29. The coupling of claim 28, further comprising at least one radially oriented magnet.

30. The coupling of claim 28, wherein at least one of the couples comprises electromagnets.

31. A magnetic coupling, comprising at least one radially aligned magnet, wherein the ratio of the average length (from the outer periphery of the magnet to the inner periphery) to average thickness (that is, the side of the magnet perpendicular to its direction of attachment to the other coupling) has a ratio of average length to average width of at least 5 to 1.

32. The coupling of claim 31, with a ratio of at least 10 to 1.

33. The coupling of claim 31, wherein the magnet set is angled between 1 and 89 degrees.

34. A magnetic coupling, associated with a rotating shaft, comprising an anti-collapsing means between the two sides of the coupling.
